(19) United States
(12) Patent Application Publication
(10) Pub. No.: US 2026/0246850 A1
(43) Pub. Date: Aug. 20, 2026

(54) Method for Performing Android Smart Device Data Communication and Apparatus therefor

(71) Applicant: Feitian Technologies Co., Ltd., Beijing (CN)

(72) Inventor: Zhou LU, Beijing (CN)

(21) Appl. No.: 18/853,387

(22) PCT Filed: Apr. 25, 2024
(86) PCT No.: PCT/CN2024/089709

§ 371 Date: Oct. 1, 2024

(30) Foreign Application Priority Data
Oct. 19, 2023 (CN) 202311352294.X

(51) Int. Cl. H04L 67/562; G06F 13/38; H04L 67/141

(52) U.S. Cl. CPC H04L 67/562; G06F 13/385; H04L 67/141; G06F 2213/0042

(57) ABSTRACT

An Android smart device data communication method, applied to an Android smart device including a data communication proxy service and an upper layer application; in the method, a data communication proxy service monitors a USB device event and waits to receive a request for establishing a local port connection sent from the upper layer application, performs a USB device event handling process when the USB device event is monitored, and performs a connection and data handling process when the request for establishing the local port connection sent from the upper layer application is received. According to the present invention, the function of network communication between the Android smart device and the iOS terminal via a USB interface is achieved, without using a third party server as a relay, and the problem of network configuration when data transmission is performed through the USB network adapter or the like is avoided.

### FIELD OF THE INVENTION

The present invention relates to a method for performing an Android smart device data communication method and apparatus therefor and belongs to the field of computer technology.

### PRIOR ART

In prior art, when it comes to data communication between the Android smart device based on the Android system and the Apple device (iOS terminal), the only option is to rely on a third party server as a relay or to establish data interaction through wireless connections such as Bluetooth or WIFI. However, these methods are prone to problems such as insecure data interaction or unstable Bluetooth and WIFI connections, which can lead to interruptions in communication between the two devices. Therefore, how to solve the problem of data interaction between Android smart devices and Apple devices has become a pressing technical problem that needs to be addressed.

### SUMMARY OF THE INVENTION

An object of the present invention is to provide a method for communicating data with an Android smart device and an apparatus therefor, which can implement a function of network communication between the Android smart device and the iOS terminal through a USB interface, without using a third party server as a relay, and the problem of network configuration when data transmission is performed through the USB network adapter or the like is avoided.

Thus, according to the first aspect of the present invention, there is provided an Android smart device data communication method, the method including:
performing a USB device event handling process when the data communication proxy service monitors a USB device event, the USB device event handling process including the steps of:

S101) determining, by the data communication proxy service, a type of the USB device event, performing Step S102 when the event type is determined to be a connection event, performing Step S104 when the event type is determined to be a disconnection event;

S102) judging, by the data communication proxy service, whether a connected USB device is an iOS terminal, and if yes, performing Step S103, otherwise, monitoring the USB device event and waiting to receive a request for establishing a local port connection sent from the upper layer application;

S103) selecting, by the data communication proxy service, a configuration mode of the iOS terminal to be a composite device mode, sending channel establishment negotiation information to the iOS terminal through a USB interface, receiving a channel establishment negotiation response, and waiting to receive the request for establishing the local port connection sent from the upper layer application;

S104) judging, by the data communication proxy service, whether a disconnected USB device is an iOS terminal, and if yes, performing Step S105, otherwise, monitoring the USB device event and waiting to receive the request for establishing the local port connection sent from the upper layer application; and

S105) judging, by the data communication proxy service, whether the local port connection with the upper layer application has been established, and if yes, disconnecting the local port connection with the upper layer application, monitoring the USB device event and waiting to receive the request for establishing the local port connection sent from the upper layer application, otherwise, monitoring the USB device event and waiting to receive the request for establishing the local port connection sent from the upper layer application;
performing a connection and data handling process when the data communication proxy service receives the request for establishing the local port connection sent from the upper layer application, the connection and data handling process including the steps of:

S201) establishing, by the data communication proxy service, the local port connection with the upper layer application, sending TCP handshake data to the iOS terminal through the USB interface to establish a connection, performing Step S202 if an exception of the establishment of the connection with the iOS terminal arises, and performing Step S203 if the establishment of the connection with the iOS terminal is successful;

S202) disconnecting, by the data communication proxy service, the local port connection with the upper layer application, monitoring the USB device event and waiting to receive the request for establishing the local port connection sent from the upper layer application;

S203) waiting, by the data communication proxy service, to receive data, performing Step S204 when TCP data is received, and performing Step S205 when USB interface data is received;

S204) organizing, by the data communication proxy service, the TCP data according to a preset format to obtain first data, sending the first data to the iOS terminal through the USB interface, and returning to Step S203;

S205) judging, by the data communication proxy service, whether to establish the local port connection with the upper layer application, and if yes, performing Step S206, otherwise, monitoring the USB device event and waiting to receive the request for establishing the local port connection sent from the upper layer application; and

S206) converting, by the data communication proxy service, the USB interface data into the TCP data, sending the TCP data to the upper layer application, and returning to Step S203.

According to the second aspect of the present invention, there is provided an Android smart device data communication apparatus, the apparatus including:
a first monitoring module, configured to monitor a USB device event and trigger a first handling module when the USB device event is monitored;
a waiting-to-receive module, configured to wait to receive a request for establishing a local port connection sent from an upper layer application, and trigger a second handling module when the request for establishing the local port connection sent from the upper layer application is received;
the first handling module including:
a determining unit, configured to determine the type of the USB device event;
a first judging unit, configured to judge whether the connected USB device is an iOS terminal, trigger a selecting and handling unit when it is determined that the connected USB device is an iOS terminal, and trigger the first monitoring module and the waiting-to-receive module when it is determined that the connected USB device is not an iOS terminal;
the selecting and handling unit, configured to select a configuration mode of the iOS terminal to be a composite device mode, send channel establishment negotiation information to the iOS terminal through a USB interface, receive a channel establishment negotiation response, and trigger the waiting-to-receive module;
a second judging unit, configured to judge whether the disconnected USB device is an iOS terminal, trigger a third judging unit when it is determined that the disconnected USB device is an iOS terminal, and trigger the first monitoring module and the waiting-to-receive module when it is determined that the disconnected USB device is not an iOS terminal; and
the third judging unit, configured to judge whether the local port connection with the upper layer application has been established, and when it is determined that the local port connection with the upper layer application has been established, disconnect the local port connection with the upper layer application, and trigger the first monitoring module and the waiting-to-receive module, and further configured to trigger the first monitoring module and the waiting-to-receive module when it is determined that the local port connection with the upper layer application has not been established;
the second handling module including:
a connecting unit, configured to establish the local port connection with the upper layer application, send TCP handshake data to the iOS terminal through the USB interface to establish a connection, and further configured to trigger a disconnecting unit when it is determined that an exception of the establishment of the connection with the iOS terminal arises, and further configured to trigger a waiting-to-receive unit when it is determined that the establishment of the connection with the iOS terminal is successful;
the disconnecting unit, configured to disconnect the local port connection with the upper layer application and trigger the first monitoring module and the waiting-to-receive module;
the waiting-to-receive unit, configured to wait to receive data, further configured to trigger the first sending unit when TCP data is received, and trigger a fourth judging unit when USB interface data is received;
the first sending unit, configured to organize the TCP data according to a preset format to obtain first data, send the first data to the iOS terminal through the USB interface, and trigger the waiting-to-receive unit;
the fourth judging unit, configured to judge whether to establish the local port connection with the upper layer application, further configured to trigger a second sending unit when it is determined that the local port connection with the upper layer application has been established, and further configured to trigger the first monitoring module and the waiting-to-receive module when it is determined that the local port connection with the upper layer application has not been established; and
the second sending unit, configured to convert the USB interface data into the TCP data, send the TCP data to the upper layer application, and trigger the waiting-to-receive unit.

According to the third aspect of the present invention, there is provided a computer readable storage medium for storing a computer program which, when executed by a processor, implements the steps of the Android smart device data communication method of the first aspect.

According to the fourth aspect of the present invention, there is provided an electronic device including a processor and a memory, the processor being configured to perform the Android smart device data communication method according to the first aspect by invoking a computer program stored in the memory.

According to the present invention, the data communication proxy service in the Android smart device implements the function of network communication and data interaction between the Android smart device and the iOS terminal via a USB interface, in particular, the upper layer application installed on the Android smart device can interact with the iOS terminal through the data communication proxy service in the Android smart device in a network communication protocol manner, without using a third party server as a relay, and the operation of network configuration when data transmission is performed through the USB network adapter or the like is avoided.

In addition, according to the present invention, the Android smart device can also power the iOS terminal.

### BRIEF DESCRIPTION OF THE DRAWINGS

For the sake of clarity, embodiments of the present invention or the prior art will be briefly described below with reference to the accompanying drawings. It is obvious that the drawings in the following description are only some embodiments of the present invention, and other drawings can be obtained from these drawings for those skilled in the art without inventive step.

FIG. 1 is a flowchart of an Android smart device data communication method according to Embodiment 1 of the present invention;

FIG. 2 is a flowchart of an Android smart device data communication method according to Embodiment 1 of the present invention;

FIG. 3 is a flowchart of an Android smart device data communication method according to Embodiment 2 of the present invention;

FIG. 4 is a flowchart of an Android smart device data communication method according to Embodiment 3 of the present invention;

FIG. 5 is a flowchart of an Android smart device data communication method according to Embodiment 4 of the present invention;

FIG. 6 is a flowchart of another Android smart device data communication method according to Embodiment 4 of the present invention; and

FIG. 7 is a flowchart of another Android smart device data communication method according to Embodiment 4 of the present invention.

### DETAILED DESCRIPTION OF PREFERRED EMBODIMENTS

In order to make the objects, technical solutions and advantages of the present invention more clear, the embodiments of the present invention will be further described in detail below with reference to the accompanying drawings.

### Embodiment 1

An Android smart device data communication method provided in Embodiment 1 of the present invention is applicable to an Android smart device in which an Android system is installed and an iOS terminal (such as an Apple Phone or IPAD) in which an iOS system is installed. In Embodiment 1, a data communication proxy service is included in the Android smart device, the Android smart device has an upper layer application installed therein, the Android smart device is connected with an iOS terminal through a USB interface, the iOS terminal includes an application service therein, and the Android smart device implements data transmission between the upper layer application and the iOS terminal through the data communication proxy service. Specifically, the data communication proxy service performs data transmission with the upper layer application through a local port, and the data communication proxy service performs data transmission with the iOS terminal through the USB interface.

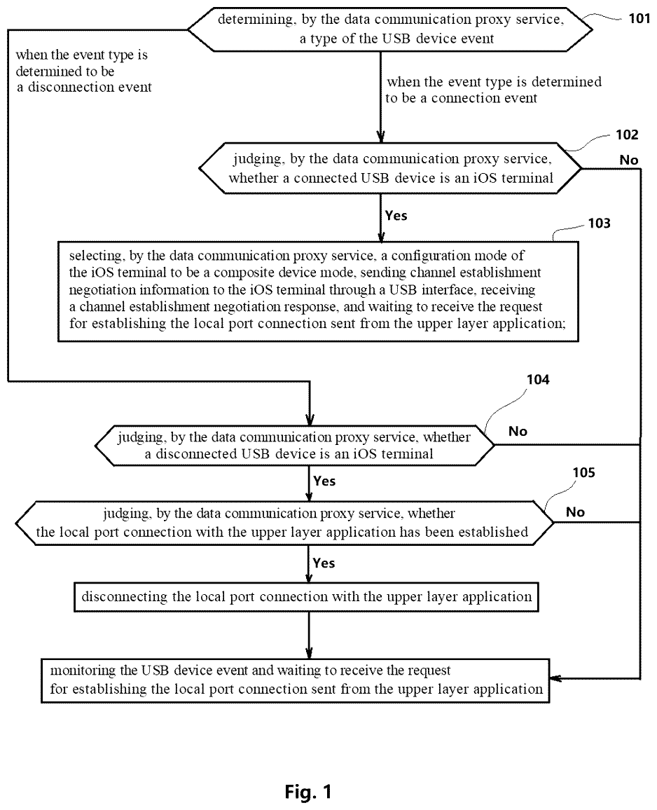

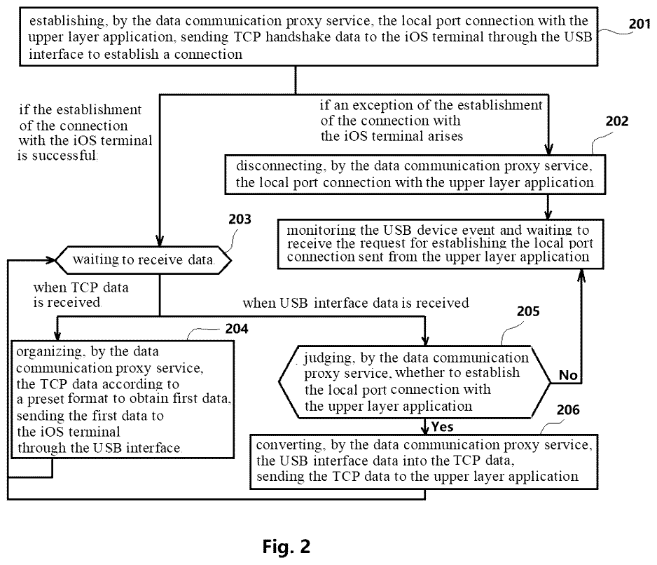

The Android smart device data communication method provided in Embodiment 1 of the present invention will be described in detail with reference to FIGS. 1 and 2. The Android smart device data communication method provided in Embodiment 1 of the present invention includes:
a data communication proxy service monitors a USB device event and waits to receive a request for establishing a local port connection sent from an upper layer application, a USB device event handling process is performed when the data communication proxy service monitors the USB device event, and a connection and data handling process is performed when the data communication proxy service receives the request for establishing a local port connection sent from the upper layer application.

Specifically, as shown in FIG. 1 which shows the USB device event handling process, the specific method steps include:

Step 101: the data communication proxy service determines a type of the USB device event, Step S102 is performed when the event type is determined to be a connection event, and Step S104 is performed when the event type is determined to be a disconnection event;
in Embodiment 1, before Step 101, the method further includes: the Android smart device is powered on, the data communication proxy service is started, and the USB device event monitoring is implemented by the data communication proxy service;
in one implementation mode, before Step 101, the method further includes: the data communication proxy service registers a local port to initiate port monitoring; and
specifically, the data communication proxy service receives a request for establishing a local port connection sent from the upper layer application through a monitored port.

Further, a Socket communication library is integrated in the upper layer application of the Android smart device, the data communication proxy service registers and monitors the plugging and unplugging of a Type-C line, and the Socket communication library is integrated in the sdk of the iOS terminal, and an IP 127.0.0.1 and a port 8000 are registered and monitored during initialization.

Step 102: the data communication proxy service judges whether the connected USB device is an iOS terminal, and if yes, Step 103 is performed, otherwise, the data communication proxy service monitors the USB device event and waits to receive the request for establishing the local port connection sent from the upper layer application;
in Embodiment 1, the judging whether the connected USB device is an iOS terminal specifically includes: a VID (Vender ID) and a PID (Product ID) of the connected USB device are obtained, and whether the connected USB device is an iOS terminal is judged according to the VID and the PID; and
specifically, each USB device has a VID and a PID; a host identifies different devices by the VID and PID.

For example, the VID and PID of the iOS terminal connected in Embodiment 1 are:
{USB_DEVICE (0x05ac, 0x12a8)}.

Step 103: the data communication proxy service selects a configuration mode of the iOS terminal to be a composite device mode, sends channel establishment negotiation information to the iOS terminal through the USB interface, receives a channel establishment negotiation response, and waits to receive the request for establishing the local port connection sent from the upper layer application;
in Embodiment 1, the composite device modes include: ptp (media transport device mode), apple mobile device (tcp multi-channel device mode), apple usb ethernet (usb ethernet card device mode); and
specifically, when the iOS terminal is connected to the device through USB communication, the iOS terminal declares a plurality of configuration modes, such as ptp (media transport device mode), mtp mode, USB network adapter mode, and the like.

Specifically, the channel establishment negotiation information includes an Android smart device version, and the channel establishment negotiation response includes an iOS terminal version;
for example, the channel establishment negotiation information in Embodiment 1 is: 00 00 00 0000 00 00 14 00 00 00 02 00 00 00 00 00 00 00 00, wherein 02 is an Android smart device version; the channel establishment negotiation response is: 00 00 00 0000 00 00 14 00 00 00 02 00 00 00 00 00 00 00 00, wherein 02 is the iOS terminal version;
in one implementation mode, after the channel establish Fhment negotiation response is received, the method further includes: a channel opening instruction is sent to the iOS terminal; and
for example, the channel opening instruction in Embodiment 1 is: 00 00 00 02 00 00 00 11 FE ED FA CE 00 00 FF FF 07.

Step 104: the data communication proxy service judges whether the disconnected USB device is an iOS terminal, and if yes, Step S105 is performed, otherwise, the data communication proxy service monitors the USB device event and waits to receive the request for establishing the local port connection sent from the upper layer application; and
in Embodiment 1, the judging whether the disconnected USB device is an iOS terminal specifically includes: connected device information before and after disconnection of the device is enumerated, the connected device information before and after disconnection is compared to determine the disconnected device, a VID (Vender ID) of the USB device is obtained from the device information before disconnection, and whether the disconnected USB device is an iOS terminal is judged based on the VID.

Step 105: the data communication proxy service judges whether a local port connection with the upper layer application has been established, and if yes, disconnects the local port connection with the upper layer application, monitors the USB device event and waits to receive the request for establishing the local port connection sent from the upper layer application, otherwise, monitors the USB device event and waits to receive the request for establishing the local port connection sent from the upper layer application.

Specifically, as shown in FIG. 2 which shows the connection and data handling process, the specific method steps include:

Step 201: the data communication proxy service establishes the local port connection with the upper layer application, sends TCP handshake data to the iOS terminal through the USB interface to establish a connection, if an exception of the establishment of the connection with the iOS terminal arises, then Step 202 is performed, if the establishment of the connection with the iOS terminal is successful, then Step 203 is performed;
in one implementation mode, the establishing the local port connection with the upper layer application specifically includes: the data communication proxy service performs handshake data transmission for a first preset number of times through the local port, and establishes a local port TCP data transmission channel; and
in one implementation mode, the sending the TCP handshake data to the iOS terminal through the USB interface to establish the connection specifically includes: the data communication proxy service simulates handshake data transmission between the upper layer application and the iOS terminal through the USB interface for a second preset number of times, and establishes a USB interface TCP data transmission channel.

Specifically, the first preset number of times is 3 times, and the second preset number of times is 3 times.

In Embodiment 1, the cases where an exception of the establishment of the connection arises include that the connected USB device is unplugged accidentally, or that the application service is not started, or that the application service in the iOS terminal is forcibly terminated by the system.

Step 202: the data communication proxy service disconnects the local port connection with the upper layer application, monitors the USB device event and waits to receive the request for establishing the local port connection sent from the upper layer application;
in one implementation mode, Step 202 further includes: the data communication proxy service prompts information;
specifically, the information includes: the iOS terminal application service is not turned on, or the connection fails or is erroneous.

Step 203: the data communication proxy service waits to receive data, when TCP data is received, Step 204 is performed, and when USB interface data is received, Step 205 is performed.

Step 204: the data communication proxy service organizes the TCP data according to a preset format to obtain first data, sends the first data to the iOS terminal through the USB interface, and returns to Step 203;
specifically, the organizing the TCP data according to the preset format to obtain the first data specifically includes: a USB data frame header is added to the TCP data to obtain the first data.

Step 205: the data communication proxy service judges whether to establish the local port connection with the upper layer application, and if yes, Step 206 is performed, otherwise, the data communication proxy service monitors the USB device event and waits to receive the request for establishing the local port connection sent from the upper layer application.

Step 206: the data communication proxy service converts the USB interface data into the TCP data, sends the TCP data to the upper layer application, and returns to Step 203.

Specifically, the converting the USB interface data into the TCP data specifically includes: the USB data frame header in the USB data is deleted to obtain the TCP data.

Specifically, the sending the TCP data to the upper layer application specifically includes: the data communication proxy service sends the TCP data to a network protocol station, and the network protocol station obtains a port number in the TCP data, and sends the TCP data to the upper layer application according to the port number.

In Embodiment 1, the Android smart device is a master device, and the iOS terminal is a slave device.

In Embodiment 1, the method further includes: an application service in the iOS terminal is started when the iOS terminal receives trigger information of a user, wherein the application service is configured to monitor a preset port;
further, the preset port may be a port registered by the data communication proxy service, or may be a specific port.

In the Android smart device data communication method provided in the present invention, the data communication proxy service in the Android smart device implements the functions of network communication and data interaction between the Android smart device and the iOS terminal via a USB interface, in particular, the upper layer application installed on the Android smart device can interact with the iOS terminal through the data communication proxy service in the Android smart device in a network communication protocol manner, without using a third party server as a relay, and the operation of network configuration when data transmission is performed through the USB network adapter or the like is avoided.

### Embodiment 2

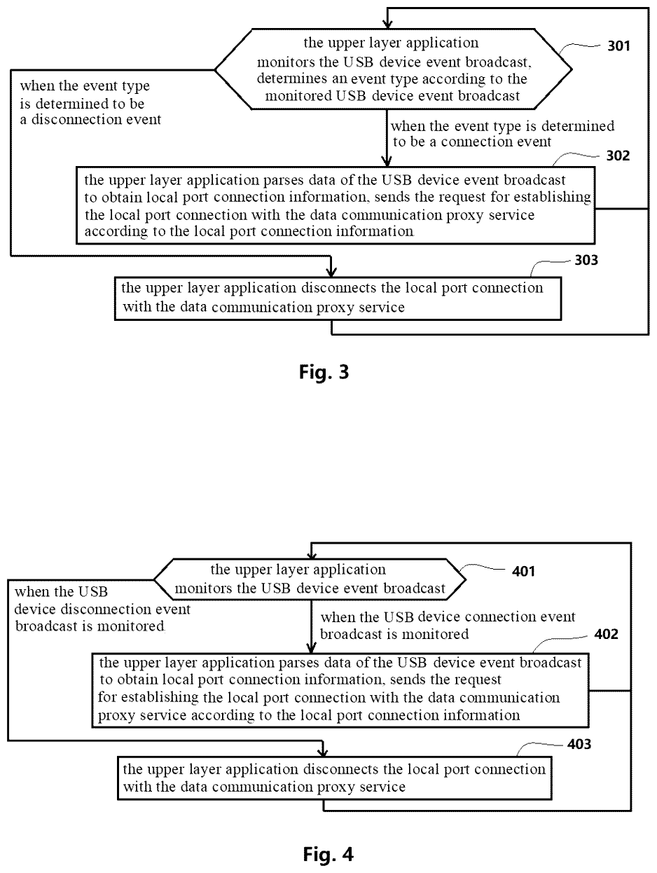

Embodiment 2 of the present invention provides an Android smart device data communication method, based on the data communication method shown in FIG. 1, in the Android smart device data communication method, when the data communication proxy service determines that the USB device being connected or disconnected is an iOS terminal, the method further includes: the data communication proxy service sends a USB device event broadcast;
specifically, as shown in FIG. 3, the method further includes:

Step 301: the upper layer application monitors the USB device event broadcast, determines an event type according to the monitored USB device event broadcast, Step S302 is performed when the event type is determined to be a connection event, and Step S303 is performed when the event type is determined to be a disconnection event;

Step 302: the upper layer application parses data of the USB device event broadcast to obtain local port connection information, sends the request for establishing the local port connection with the data communication proxy service according to the local port connection information, and returns to Step S301; and

Step 303: the upper layer application disconnects the local port connection with the data communication proxy service, and returns to Step S301.

Specifically, after the upper layer application sends the request for establishing the local port connection with the data communication proxy service, the data communication proxy service performs a connection and data handling process;
further, the upper layer application establishes the local port connection with the data communication proxy service and sends TCP data to the data communication proxy service through a network protocol layer.

In Embodiment 2, specifically, when the iOS terminal is connected with the Android smart device through the Type-C line, the upper layer application of the Android smart device monitors the USB device event broadcast sent from the data communication proxy service, the upper layer application actively establishes a connection with a fixed IP and the local port when the monitored USB device event broadcast is a connection event broadcast; when the iOS terminal is disconnected from the Android smart device through the Type-C line, the upper layer application of the Android smart device monitors the USB device event broadcast sent from the data communication proxy service, the upper layer application actively disconnects the previously established connection with the fixed IP and the local port when the monitored USB device event broadcast is a disconnection event broadcast.

### Embodiment 3

Embodiment 3 of the present invention provides an Android smart device data communication method, based on the data communication method shown in FIG. 1, wherein the Android smart device further includes a power management service, the method further includes:
when the data communication proxy service determines that the connected USB device is an iOS terminal, the power management service is notified that the USB device has been connected; and
when it is determined that the disconnected USB device is an iOS terminal, the power management service is notified that the USB device has been unplugged.

In one implementation mode, the method further includes:
when the power management service receives a notification that the USB device has been connected, the power management service turns on an OTG (on-the-go) power supply mode to charge the iOS terminal; and
when the power management service receives a notification that the USB device has been unplugged, the power management service turns off the OTG power supply mode.

In Embodiment 3, before Step 101, the method further includes: the Android smart device starts a data communication proxy service and a power management service.

In one implementation mode, after the power management service turns on the OTG power supply mode to charge the iOS terminal, the method further includes: the power management service sends a device connection event broadcast; and after the power management service turns off the OTG power supply mode, the method further includes: the power management service sends a device disconnection event broadcast;
specifically, as shown in FIG. 4, after the power management service sends the USB device event broadcast, the method further includes:

Step 401: the upper layer application monitors the USB device event broadcast, when the USB device connection event broadcast is monitored, Step S402 is performed, and when the USB device disconnection event broadcast is monitored, Step S403 is performed;

Step 402: the upper layer application parses data of the USB device event broadcast to obtain local port connection information, sends the request for establishing the local port connection with the data communication proxy service according to the local port connection information, and returns to Step S401; and

Step 403: the upper layer application disconnects the local port connection with the data communication proxy service, and returns to Step S401.

For the Android smart device data communication method provided in the present invention, in particular, the Android smart device and the iOS terminal are connected through a Type-C line, the upper layer application in the Android smart device is in wired communication with the iOS terminal through the data communication proxy service socket, so that the Android smart device and the iOS terminal perform data interaction through the USB connection mode, and meanwhile, the present solution can supply power to the iOS terminal through the power management service in the Android smart device, and solve the problem of insufficient power supply to the iOS terminal.

### Embodiment 4

Embodiment 4 of the present invention provides an Android smart device data communication method, and based on the data communication methods shown in FIGS. 1 and 2, detailed description is made on the port connection between the upper layer application and the data communication proxy service and the corresponding data transmission solution in the Android smart device data communication method.

In one implementation mode, when the Android smart device includes a plurality of upper layer applications, the upper layer applications can also send requests for establishing a local port connection to a specific port; the data communication proxy service registers and monitors the port and receives the requests for establishing the local port connection sent from the plurality of upper layer applications;
specifically, the specific port is 8000.

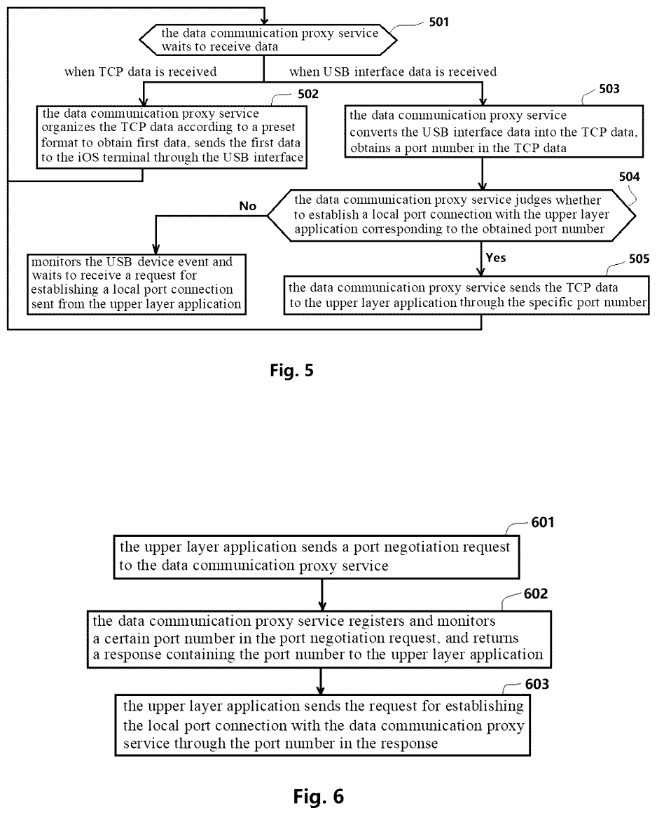

In Embodiment 4, as shown in FIG. 5, the data communication proxy service in the Android smart device waiting to receive data and performing handling specifically includes:
Step 501: the data communication proxy service waits to receive data, when TCP data is received, Step S502 is performed, and when USB interface data is received, Step S503 is performed;
Step 502: the data communication proxy service organizes the TCP data according to a preset format to obtain first data, sends the first data to the iOS terminal through the USB interface, and returns to Step 501;
specifically, the organizing the TCP data according to the preset format to obtain the first data specifically includes: the data communication proxy service adds a USB data frame header to the TCP data to obtain the first data;
Step 503: the data communication proxy service converts the USB interface data into the TCP data, obtains a port number in the TCP data, and performs Step 504;
specifically, the converting the USB interface data into the TCP data specifically includes: the USB data frame header in the USB data is deleted to obtain the TCP data;
Step 504: the data communication proxy service judges whether to establish a local port connection with the upper layer application corresponding to the obtained port number, and if yes, performs Step S505, otherwise, monitors the USB device event and waits to receive a request for establishing a local port connection sent from the upper layer application; and
for example, the specific port number of the data communication proxy service is 8000, the local port number of the upper layer application 1 is 1234, and the local port number of the upper layer application 2 is 1220;
when both the upper layer application 1 and the upper layer application 2 establish a connection with a specific port of the data communication proxy service, the data communication proxy service receives the USB interface data sent from the iOS terminal through the USB interface, and converts the USB interface data into TCP data, and when the obtained port number in the TCP data is 1220, the data communication proxy service judges whether an upper layer application corresponding to the obtained port number 1220 establishes a connection with its specific port 8000;
Step 505: the data communication proxy service sends the TCP data to the upper layer application through the specific port number, and returns to Step 501.

Specifically, the sending the TCP data to the upper layer application through the specific port number specifically includes: the data communication proxy service sends the TCP data to a network protocol stack, and the network protocol stack forwards the TCP data to an upper layer application corresponding to the port number in the TCP data among the plurality of upper layer applications.

In another implementation mode, the Android smart device includes a plurality of upper layer applications, the data communication proxy service registers and monitors a port within a preset range, the port range monitored by the iOS terminal coincides with the port registered and monitored by the data communication proxy service, the upper layer applications can also transmit requests for establishing the local port connection with a port that is not a specific port specifically, the data communication proxy service is a main service, and sub-services can be created; or the data communication proxy service is a service pool;
specifically, the port numbers in the preset range are 8000-8100.

Specifically, when the data communication proxy service receives requests for establishing the local port connection sent from a plurality of upper layer applications, the data communication proxy service opens an equal number of sub-services corresponding to the upper layer applications; the sub-service is configured to establish the local port connection with the upper layer application, and is also configured to wait to receive the TCP data or USB interface data;
for example, the registered port number range of the data communication proxy service is 8000-8100, the local port number of the upper layer application 1 is 1234, the local port number of the upper layer application 2 is 1220, and the port number range monitored by the iOS terminal side is 8000-8100; and
when the upper layer application 1 and the upper layer application 2 establish connections with the ports 8000 and 8010 of the data communication proxy service, respectively, the data communication proxy service opens 2 sub-services, the first sub-service has a port number of 8000 and the second sub-service has a port number of 8010, and correspondingly, the first sub-service establishes a connection with the port 8000 of the iOS terminal and the second sub-service establishes a connection with the port 8010 of the iOS terminal; the data communication proxy service waiting to receive data specifically includes: when the first sub-service in the data communication proxy service receives the USB interface data sent from the iOS terminal through the USB interface, and converts the USB interface data into the TCP data, and when the obtained port number in the TCP data is 1234, the first sub-service in the data communication proxy service judges whether an upper layer application corresponding to the obtained port number 1234 is connected to its specific port 8000.

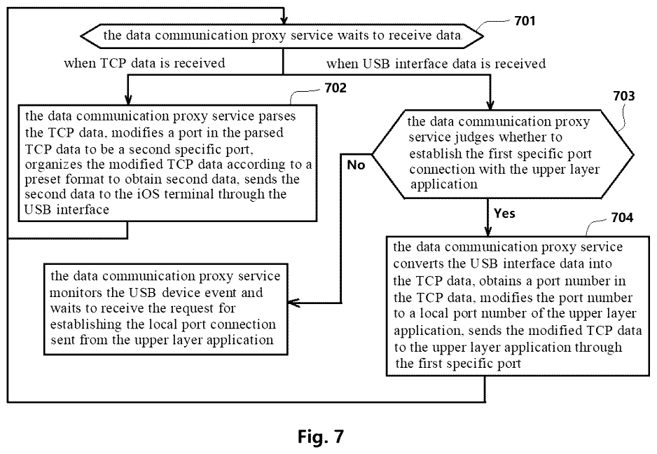

In yet another implementation mode, the data communication proxy service registers and monitors a specific port, and the iOS terminal monitors a negotiated port number; the embodiment is mainly directed to unspecific iOS terminals, the port numbers of different iOS terminals are different, and therefore, the port numbers can be dynamically negotiated through the upper layer application and the data communication proxy service in the Android smart device, specifically, as shown in FIG. 6, before Step 201, the method further includes:
Step 601: the upper layer application sends a port negotiation request to the data communication proxy service; specifically, the upper layer application sends a request for establishing a specific port connection and sends a port negotiation request to the data communication proxy service;
Step 602: the data communication proxy service registers and monitors a certain port number in the port negotiation request, and returns a response containing the port number to the upper layer application; and
Step 603: the upper layer application sends the request for establishing the local port connection with the data communication proxy service through the port number in the response.

Specifically, after the data communication proxy service establishes a connection with the upper layer application, the data communication proxy service receives data sent from the upper layer application through the connection channel.

In yet another implementation mode, the data communication proxy service registers and monitors a first special port, and the iOS terminal monitors a second special port; this embodiment is mainly directed to unspecific iOS terminals, the port numbers of different iOS terminals are different, therefore, the data sent from the upper layer application can be forwarded by the data communication proxy service in the Android smart device according to the negotiated port number. Specifically, the upper layer application establishes a first specific port connection with the data communication proxy service, and the data communication proxy service establishes a second specific port connection with the iOS terminal.

Further, as shown in FIG. 7, the data communication proxy service waiting to receive data and performing handling specifically includes:
Step 701: the data communication proxy service waits to receive data, when TCP data is received, Step 702 is performed, and when USB interface data is received, Step 703 is performed;
Step 702: the data communication proxy service parses the TCP data, modifies a port in the parsed TCP data to be a second specific port, organizes the modified TCP data according to a preset format to obtain second data, sends the second data to the iOS terminal through the USB interface, and returns to Step S701;
specifically, the organizing the modified TCP data according to the preset format to obtain the second data specifically includes: the data communication proxy service adds a USB data frame header to the modified TCP data to obtain the second data;
further, the organizing the modified TCP data according to the preset format to obtain the second data specifically includes: the data communication proxy service recalculates a checksum in the TCP data with the modified port number, organizes to obtain the modified TCP data according to the calculated checksum, and adds a USB data frame header to the modified TCP data to obtain the second data;
Step 703: the data communication proxy service judges whether to establish the first specific port connection with the upper layer application, and if yes, Step S704 is performed, otherwise, the data communication proxy service monitors the USB device event and waits to receive the request for establishing the local port connection sent from the upper layer application; and
Step 704: the data communication proxy service converts the USB interface data into the TCP data, obtains a port number in the TCP data, modifies the port number to a local port number of the upper layer application, sends the modified TCP data to the upper layer application through the first specific port, and returns to Step S701.

Specifically, the converting the USB interface data into the TCP data specifically includes: the data communication proxy service deletes a USB data frame header in the USB interface data to obtain the TCP data.

Further, the sending the modified TCP data to the upper layer application through the first specific port specifically includes: the data communication proxy service recalculates a checksum in the TCP data whose port number is modified to the local port number of the upper layer application, organizes to obtain the modified TCP data according to the calculated checksum, and sends the modified TCP data to the upper layer application through the first specific port.

Specifically, the sending the modified TCP data to the upper layer application through the first specific port specifically includes: the data communication proxy service sends the TCP data to the network protocol stack through the first specific port, and the network protocol stack forwards the TCP data to the upper layer application corresponding to the port number in the TCP data.

In the Android smart device data communication method provided in the present invention, the data communication proxy service in the Android smart device implements the functions of network communication and data interaction between the Android smart device and the iOS terminal via a USB interface, in particular, the upper layer application installed on the Android smart device can interact with the iOS terminal through the data communication proxy service in the Android smart device in a network communication protocol manner, without using a third party server as a relay, and the operation of network configuration when data transmission is performed through the USB network adapter or the like is avoided.

The apparatus of the present invention is configured to perform the method of the present invention. For details not disclosed in embodiments of the apparatus of the present invention, reference may be made to embodiments of the method of the present invention.

An Android smart device data communication apparatus provided in an exemplary embodiment of the present invention includes:
a first monitoring module, configured to monitor a USB device event and trigger a first handling module when the USB device event is monitored;
a waiting-to-receive module, configured to wait to receive a request for establishing a local port connection sent from an upper layer application, and trigger a second handling module when the request for establishing the local port connection sent from the upper layer application is received;
the first handling module including: a determining unit, configured to determine a type of the USB device event;
a first judging unit, configured to judge whether the connected USB device is an iOS terminal, trigger a selecting and handling unit when it is determined that the connected USB device is an iOS terminal, and trigger the first monitoring module and the waiting-to-receive module when it is determined that the connected USB device is not an iOS terminal;
the selecting and handling unit, configured to select a configuration mode of the iOS terminal to be a composite device mode, send channel establishment negotiation information to the iOS terminal through a USB interface, receive a channel establishment negotiation response, and trigger the waiting-to-receive module;
a second judging unit, configured to judge whether the disconnected USB device is an iOS terminal, trigger a third judging unit when it is determined that the disconnected USB device is an iOS terminal, and trigger the first monitoring module and the waiting-to-receive module when it is determined that the disconnected USB device is not an iOS terminal; and
the third judging unit, configured to judge whether the local port connection with the upper layer application has been established, and when it is determined that the local port connection with the upper layer application has been established, disconnect the local port connection with the upper layer application, and trigger the first monitoring module and the waiting-to-receive module, and further configured to trigger the first monitoring module and the waiting-to-receive module when it is determined that the local port connection with the upper layer application has not been established;

the second handling module including:
a connecting unit, configured to establish the local port connection with the upper layer application, transmit TCP handshake data to the iOS terminal through the USB interface to establish a connection, and further configured to trigger a disconnecting unit when it is determined that an exception of the establishment of the connection with the iOS terminal arises, and further configured to trigger a waiting-to-receive unit when it is determined that the establishment of the connection with the iOS terminal is successful;
the disconnecting unit, configured to disconnect the local port connection with the upper layer application and trigger the first monitoring module and the waiting-to-receive module;
the waiting-to-receive unit, configured to wait to receive data, further configured to trigger a first sending unit when TCP data is received, and trigger a fourth judging unit when USB interface data is received;
the first sending unit, configured to organize the TCP data according to a preset format to obtain first data, send the first data to the iOS terminal through a USB interface, and trigger the waiting-to-receive unit;
the fourth judging unit, configured to judge whether to establish the local port connection with the upper layer application, further configured to trigger a second sending unit when it is determined that the local port connection with the upper layer application has been established, and further configured to trigger the first monitoring module and the waiting-to-receive module when it is determined that the local port connection with the upper layer application has not been established; and
the second sending unit, configured to convert the USB interface data into the TCP data, send the TCP data to the upper layer application, and trigger the waiting-to-receive unit.

It should be noted that, when the data communication method is performed by the Android smart device data communication apparatus provided in the above embodiments, only the division of the above-described functional modules is illustrated, in practice, the above-described functions may be distributed and performed by different functional modules as needed, i.e., the internal structure of the device is divided into different functional modules to perform all or part of the above-described functions. In addition, the Android smart device data communication apparatus provided in the above embodiment belongs to the same concept as the Android smart device data communication method embodiment, and its implementation process is detailed in the method embodiment, which will not be repeated here.

The above-described sequence numbers of the embodiments of the present invention are merely illustrative and do not represent the superiority or inferiority of the embodiments.

In the Android smart device data communication method and apparatus provided in the present invention, the data communication proxy service in the Android smart device implements the functions of network communication and data interaction between the Android smart device and the iOS terminal via a USB interface, in particular, the upper layer application installed on the Android smart device can interact with the iOS terminal through the data communication proxy service in the Android smart device in a network communication protocol manner, without using a third party server as a relay, and the operation of network configuration when data transmission is performed through the USB network adapter or the like is avoided. Meanwhile, the present solution is capable of supplying power to the iOS terminal through the power management service in the Android smart device, thus solving the problem that the iOS terminal is insufficiently supplied with power.

The present invention also provides a computer-readable storage medium having stored thereon a computer program which, when executed by a processor, implements the steps of any one of the preceding embodiment methods. The computer readable storage medium may include, but is not limited to, any type of disk including floppy disks, optical discs, DVDs, CD-ROMs, microdrives, and magneto-optical disks, ROMs, RAMs, EPROMs, EEPROMs, DRAMs, VRAMs, flash memory devices, magnetic or optical cards, nanosystems (including molecular memory ICs), or any type of medium or device suitable for storing instructions and/or data.

The present invention provides an electronic device including a processor and a memory, the processor being configured to perform the Android smart device data communication method according to the first aspect above by invoking a computer program stored in the memory.

In the present invention, the terms “first”, “second”, etc., are used for descriptive purposes only and are not to be construed as indicating or implying relative importance or order; the term “plurality” refers to two or more, unless expressly specified otherwise. “And/or” can represent the following three scenarios: A exists alone, A and B exist simultaneously, and B exists alone. The character “/” generally indicates that the objects before and after it have an “or” relationship. The terms “mounted”, “coupled”, “connected”, “secured”. etc. should all be understood broadly. For instance, “connected” can refer to fixedly connected, detachably connected, or integrally connected; “coupled” can refer to directly coupled or indirectly coupled through an intermediate medium. For those skilled in the art, the specific meanings of these terms in the present invention can be understood based on specific circumstances.

In the description of the present invention, it needs to be understood that an orientation or positional relationship indicated by the terms “upper”, “lower” and the like is based on the orientation or positional relationship shown in the drawings, only for ease of description of the present invention and for simplicity of description, and do not indicate or imply that the indicated device or unit must have a particular orientation, be constructed and operate in a particular orientation, and therefore, are not to be construed as limiting the present invention.

The above description is only specific embodiments of the present invention, but the protection scope of the present invention is not limited thereto, and variations or substitutions that can be easily thought of by those skilled in the art within the technical scope of the present invention disclosed herein should be covered by the protection scope of the present invention. Accordingly, the equivalent variations made in accordance with the claims of the present invention remain within the scope of the present invention.

1. A method for performing an Android smart device data communication, the method being applicable to an Android smart device comprising a data communication proxy service and an upper layer application, wherein the method comprises:
performing a USB device event handling process when the data communication proxy service monitors a USB device event, the USB device event handling process comprising the steps of:
S101) determining, by the data communication proxy service, a type of the USB device event, performing Step S102 when the event type is determined to be a connection event, and performing Step S104 when the event type is determined to be a disconnection event;
S102) judging, by the data communication proxy service, whether a connected USB device is an iOS terminal, and if yes, performing Step S103, otherwise, monitoring any USB device event and waiting to receive a request for establishing a local port connection sent from the upper layer application;
S103) selecting, by the data communication proxy service, a configuration mode of the iOS terminal to be a composite device mode, sending channel establishment negotiation information to the iOS terminal through a USB interface, receiving a channel establishment negotiation response, and waiting to receive the request for establishing the local port connection sent from the upper layer application;
S104) judging, by the data communication proxy service, whether a disconnected USB device is an iOS terminal, and if yes, performing Step S105, otherwise, monitoring any USB device event and waiting to receive the request for establishing the local port connection sent from the upper layer application; and
S105) judging, by the data communication proxy service, whether the local port connection with the upper layer application has been established, and if yes, disconnecting the local port connection with the upper layer application, monitoring any USB device event and waiting to receive the request for establishing the local port connection sent from the upper layer application, otherwise, monitoring any USB device event and waiting to receive the request for establishing the local port connection sent from the upper layer application;
performing a connection and data handling process when the data communication proxy service receives the request for establishing the local port connection sent from the upper layer application, the connection and data handling process comprising the steps of:
S201) establishing, by the data communication proxy service, the local port connection with the upper layer application, sending TCP handshake data to the iOS terminal through the USB interface to establish a connection, performing Step S202 if an exception of the establishment of the connection with the iOS terminal arises, and performing Step S203 if the establishment of the connection with the iOS terminal is successful;
S202) disconnecting, by the data communication proxy service, the local port connection with the upper layer application, monitoring any USB device event and waiting to receive the request for establishing the local port connection sent from the upper layer application;
S203) waiting, by the data communication proxy service, to receive data, performing Step S204 when TCP data is received, and performing Step S205 when USB interface data is received;
S204) organizing, by the data communication proxy service, the TCP data according to a preset format to obtain first data, sending the first data to the iOS terminal through the USB interface, then returning to Step S203;
S205) judging, by the data communication proxy service, whether to establish the local port connection with the upper layer application, and if yes, performing Step S206, otherwise, monitoring any USB device event and waiting to receive the request for establishing the local port connection sent from the upper layer application; and
S206) converting, by the data communication proxy service, the USB interface data into the TCP data, sending the TCP data to the upper layer application, then returning to Step S203.

2. The method according to claim 1, wherein when any USB device event is monitored, the method further comprises: sending, by the data communication proxy service, a USB device event broadcast;
the method further comprises the steps of:
S301) monitoring, by the upper layer application, the USB device event broadcast, determining an event type according to the USB device event broadcast monitored, performing Step S302 when the event type is determined to be a connection event, while performing Step S303 when the event type is determined to be a disconnection event;
S302) parsing, by the upper layer application, the USB device event broadcast to obtain local port connection information, sending the request for establishing the local port connection with the data communication proxy service according to the local port connection information, then returning to Step S301; and
S303) disconnecting, by the upper layer application, the local port connection with the data communication proxy service, then returning to Step S301.

3. The method according to claim 1, wherein the Android smart device further comprises a power management service;
when it is determined in the Step S102 that the connected USB device is an iOS terminal, the Step S103 further comprises: notifying the power management service that the USB device has been connected; and
when it is determined in the Step S104 that the disconnected USB device is an iOS terminal, the Step S105 further comprises: notifying the power management service that the USB device has been unplugged.

4. The method according to claim 3, wherein said method further comprises:
when the power management service receives a notification that the USB device has been connected, turning on, by the power management service, an OTG (on-the-go) power supply mode to charge the iOS terminal; and
when the power management service receives a notification that the USB device has been unplugged, turning off, by the power management service, the OTG power supply mode.

5. The method according to claim 4, wherein when the power management service turns on the OTG power supply mode to charge the iOS terminal or turns off the OTG power supply mode, the method further comprises: sending, by the power management service, a USB device event broadcast, which specifically comprises:
after the power management service turns on the OTG power supply mode to charge the iOS terminal, the method further comprises: sending, by the power management service, a device connection event broadcast; and
after the power management service turns off the OTG power supply mode, the method further comprises: sending, by the power management service, a device disconnection event broadcast.

6. The method according to claim 5, wherein said method further comprises the steps of:
S401) monitoring, by the upper layer application, the USB device event broadcast, performing Step S402 when the USB device connection event broadcast is monitored, while performing Step S403 when the USB device disconnection event broadcast is monitored;
S402) parsing, by the upper layer application, data of the USB device event broadcast to obtain local port connection information, sending the request for establishing the local port connection with the data communication proxy service according to the local port connection information, then returning to Step S401; and
S403) disconnecting, by the upper layer application, the local port connection with the data communication proxy service, then returning to Step S401.

7. The method according to claim 1, wherein the judging, by the data communication proxy service, whether the connected USB device is the iOS terminal specifically comprises: obtaining, by the data communication proxy service, a Vender ID (VID) and a Product ID (PID) of the connected USB device, and judging whether the connected USB device is an iOS terminal according to the VID and the PID.

8. The method according to claim 1, wherein the preset format is a USB data format;
for organizing, by the data communication proxy service, the TCP data according to the preset format to obtain the first data, it specifically comprises: adding, by the data communication proxy service, a USB data frame header to the TCP data to obtain the first data; and
for converting, by the data communication proxy service, the USB interface data into the TCP data, it specifically comprises: deleting, by the data communication proxy service, the USB data frame header in the USB interface data to obtain the TCP data.

9. The method according to claim 1, wherein for establishing, by the data communication proxy service, the local port connection with the upper layer application, it specifically comprises: performing handshake data transmission for a first preset number of times through a local port, and establishing a local port TCP data transmission channel; and
for sending the TCP handshake data to the iOS terminal through the USB interface to establish the connection, it specifically comprises: simulating, by the data communication proxy service, handshake data transmission between the upper layer application and the iOS terminal through the USB interface for a second preset number of times, and establishing a USB interface TCP data transmission channel.

10. The method according to claim 1, wherein when there are a plurality of upper layer applications, the data communication proxy service registers and monitors any port, receives requests for establishing the local port connection sent from the plurality of upper layer applications, then performs Step S201 to Step S202; and
Step S205 specifically comprises: obtaining a port number in the TCP data, judging whether to establish the port connection with an upper layer application corresponding to the port number obtained, and if yes, performing Step S206, otherwise, monitoring the USB device event and waiting to receive the request for establishing the local port connection sent from the upper layer application.

11. The method according to claim 1, wherein there are a plurality of upper layer applications, and the data communication proxy service registers and monitors a port within a preset range, and when the requests for establishing the local port connection sent from the plurality of upper layer applications are received, the data communication proxy service creates an equal number of sub-services corresponding to the upper layer applications, and performs Steps S201 to S206 through the sub-services.

12. The method according to claim 1, wherein said method further comprises, before the Step S201:
receiving, by the data communication proxy service, a port negotiation request sent from the upper layer application, registering and monitoring a port number in the port negotiation request, and returning a response containing the port number to the upper layer application; and
when the data communication proxy service receives the request for establishing the local port connection comprising the port number in the negotiation request sent from the upper layer application, performing Step S201.

13. The method according to claim 1, wherein when the port number registered and monitored by the data communication proxy service is for a first specific port, the port monitored by the iOS terminal is a second specific port, and when the first specific port is different from the second specific port, the data communication proxy service establishes a first specific port connection with the upper layer application, and the data communication proxy service establishes a second specific port connection with the iOS terminal;
Steps S203 to S206 specifically comprise the steps of:
S701) waiting to receive data, performing Step S702 when the TCP data is received, and performing Step S703 when the USB interface data is received;
S702) parsing the TCP data, modifying a port in a parsed TCP data to be a second specific port, organizing the modified TCP data according to a preset format to obtain the second data, sending the second data to the iOS terminal through the USB interface, then returning to Step S701;
S703) judging whether to establish the first specific port connection with the upper layer application, and if yes, performing Step S704, otherwise, monitoring the USB device event and waiting to receive the request for establishing the local port connection sent from the upper layer application; and
S704) converting the USB interface data into the TCP data, obtaining a port number in the TCP data, modifying the port number to a local port number of the upper layer application, sending the modified TCP data to the upper layer application through the first specific port, then returning to Step S701.

14. The method according to claim 1, wherein said method further comprises: when the iOS terminal receives trigger information from a user, starting an application service in the iOS terminal, in which the application service is configured to monitor a preset port.

15. An apparatus for performing an Android smart device data communication, wherein said apparatus comprises:
a first means for monitoring a USB device event, the first means for monitoring is configured to trigger a first means for handling when the USB device event is monitored;
a means for waiting-to-receive a request for establishing a local port connection sent from an upper layer application, the means for waiting-to-receive is configured to trigger a second means for handling when the request for establishing the local port connection sent from the upper layer application is received;
the first means for handling comprising: a unit for determining a type of the USB device event;
a first unit for judging whether the connected USB device is an iOS terminal, the first unit for judging id configured to trigger a unit for selecting and handling when it is determined that the connected USB device is an iOS terminal, and trigger the first means for monitoring and the means for waiting-to-receive when it is determined that the connected USB device is not an iOS terminal;
the unit for selecting and handling is configured to select a configuration mode of the iOS terminal to be a composite device mode, send channel establishment negotiation information to the iOS terminal through a USB interface, receive a channel establishment negotiation response, and trigger the means for waiting-to-receive;
a second unit for judging whether the disconnected USB device is an iOS terminal, the second unit for judging is configured to trigger a third unit for judging when it is determined that the disconnected USB device is an iOS terminal, and trigger the first means for monitoring and the means for waiting-to-receive when it is determined that the disconnected USB device is not an iOS terminal; and
the third unit for judging whether the local port connection with the upper layer application has been established, and when it is determined that the local port connection with the upper layer application has been established, the third unit for judging is configured to disconnect the local port connection with the upper layer application, and trigger the first means for monitoring and the means for waiting-to-receive, and further configured to trigger the first means for monitoring and the means for waiting-to-receive when it is determined that the local port connection with the upper layer application has not been established;
the second means for handling comprising:
a unit for connecting is configured to establish the local port connection with the upper layer application, send TCP handshake data to the iOS terminal through the USB interface to establish a connection, and further configured to trigger a unit for disconnecting when it is determined that an exception of establishment of the connection with the iOS terminal arises, and further configured to trigger a means for waiting-to-receive unit when it is determined that establishment of the connection with the iOS terminal is successful;
the unit for disconnecting is configured to disconnect a local port connection with the upper layer application and trigger the first means for monitoring and the means for waiting-to-receive;
the unit for waiting-to-receive is configured to wait to receive data, further configured to trigger the first unit for sending when TCP data is received, and trigger a fourth unit for judging when USB interface data is received;
the first unit for sending is configured to organize the TCP data according to a preset format to obtain first data, send the first data to the iOS terminal through the USB interface, and trigger the unit for waiting-to-receive;
the fourth unit for judging is configured to judge whether to establish the local port connection with the upper layer application, further configured to trigger a second unit for sending when it is determined that the local port connection with the upper layer application has been established, and further configured to trigger the first means for monitoring and the means for waiting-to-receive when it is determined that the local port connection with the upper layer application has not been established; and
the second unit for sending is configured to convert the USB interface data into the TCP data, send the TCP data to the upper layer application, and trigger the unit for waiting-to-receive.

16. A computer-readable storage medium or an electronic device, wherein
the computer-readable storage medium stores thereon a computer program which, when executed by a processor, implements the steps of the method according to claim 1; or
the electronic device comprises a processor and a memory, the processor is configured to perform the method according to claim 1 by invoking a computer program stored in the memory.
